(19) United States
(12) Patent Application Publication
(10) Pub. No.: US 2024/0246289 A1
(43) Pub. Date: Jul. 25, 2024

(54) THREE-DIMENSIONAL PRINTING WITH POST-PROCESSING AGENTS

(71) Applicant: Hewlett-Packard Development Company, L.P., Spring, TX (US)

(72) Inventors: Emre Hiro Discekici, San Diego, CA (US); Shannon Reuben Woodruff, San Diego, CA (US); Alay Yemane, San Diego, CA (US)

(21) Appl. No.: 18/289,702

(22) PCT Filed: May 17, 2021
(86) PCT No.: PCT/US2021/032672

§ 371 Date: Nov. 6, 2023

(51) Int. Cl. B29C 64/165; B29C 64/35; B33Y 10/00; B33Y 30/00; B33Y 40/20; B33Y 70/00

(52) U.S. Cl. CPC B29C 64/165; B29C 64/35; B33Y 10/00; B33Y 30/00; B33Y 40/20; B33Y 70/00

(57) ABSTRACT

The present disclosure describes three-dimensional printing kits, methods of making three-dimensional printed objects, and three-dimensional printing systems. In one example, a three-dimensional printing kit can include a power bed material including thermoplastic polymer particles, a fusing agent to selectively apply to the powder bed material, and a post-processing agent to apply to a three-dimensional printed object. The fusing agent can include water and a radiation absorber that absorbs radiation and converts the radiation energy to heat. The post-processing agent can include a curable epoxy resin, where the epoxy resin, when cured, has a higher elastic modulus than the thermoplastic polymer particles.

### BACKGROUND

Methods of three-dimensional (3D) digital printing, a type of additive manufacturing, have continued to be developed over the last few decades. However, systems for three-dimensional printing have historically been very expensive, though those expenses have been coming down to more affordable levels recently. Three-dimensional printing technology can shorten the product development cycle by allowing rapid creation of prototype models for reviewing and testing. Unfortunately, the concept has been somewhat limited with respect to commercial production capabilities because the range of materials used in three-dimensional printing is likewise limited. Accordingly, it can be difficult to three-dimensionally print functional parts with desired properties such as mechanical strength, visual appearance, and so on. Nevertheless, several commercial sectors such as aviation and the medical industry have benefitted from the ability to rapidly prototype and customize parts for customers.

### BRIEF DESCRIPTION OF THE DRAWINGS

FIG. 1 is a schematic view of an example three-dimensional printing kit in accordance with the present disclosure.

FIG. 2 is a flowchart illustrating an example method of making a three-dimensional printed object in accordance with the present disclosure.

FIGS. 3A-3C are schematic views of an example three-dimensional printing system in accordance with the present disclosure.

FIG. 4 is a side view of an example three-dimensional printed object in accordance with the present disclosure.

FIG. 5 is a schematic view of an example three-dimensional printing system in accordance with the present disclosure.

FIG. 6 is a graph of Young's modulus of sample three-dimensional printed objects in accordance with the present disclosure.

FIG. 7 is a graph of tensile strength of sample three-dimensional printed objects in accordance with the present disclosure.

FIG. 8 is a graph of percent strain at break of sample three-dimensional printed objects in accordance with the present disclosure.

### DETAILED DESCRIPTION

The present disclosure describes three-dimensional printing kits, methods of making three-dimensional printed objects, three-dimensional printed objects made using the methods, and three-dimensional printing systems. In one example, a three-dimensional printing kit includes a powder bed material including thermoplastic polymer particles. The kit also includes a fusing agent including water and a radiation absorber to selectively apply to the powder bed material. The radiation absorber absorbs radiation and converts the radiation energy to heat. The kit also includes a post-processing agent to apply to a three-dimensional printed object. The post-processing agent includes a curable epoxy resin. The epoxy resin, when cured, has a higher elastic modulus than the thermoplastic polymer particles. In some examples, the curable epoxy resin can be a one-part UV-curable epoxy resin or a two-part composition including an epoxy part and a hardener part. In further examples, the post-processing agent can be a 100% solids epoxy coating composition. In alterative examples, the post-processing agent can include a diluted epoxy resin in a liquid vehicle. In certain examples, the thermoplastic polymer particles can include polyamide-6, polyamide-9, polyamide-11, polyamide-12, polyamide-6,6, polyamide-6,12, thermoplastic polyamide, polyamide copolymer, polyethylene, thermoplastic polyurethane, polypropylene, polyester, polycarbonate, polyether ketone, polyacrylate, polystyrene, polyvinylidene fluoride, polyvinylidene fluoride copolymer, poly(vinylidene fluoride-trifluoroethylene), poly(vinylidene fluoride-trifluoroethylene-chlorotrifluoroethylene), wax, or a combination thereof. In other examples, the radiation absorber can be a metal dithiolene complex, carbon black, a near-infrared absorbing dye, a near-infrared absorbing pigment, metal nanoparticles, a tungsten bronze, a molybdenum bronze, a conjugated polymer, or a combination thereof.

The present disclosure also describes methods of making three-dimensional printed objects. In one example, a method of making a three-dimensional printed object includes iteratively applying individual build material layers of thermoplastic polymer particles to a powder bed. A fusing agent is selectively applied, based on a three-dimensional object model, onto the individual build material layers. The fusing agent includes water and a radiation absorber, where the radiation absorber absorbs radiation and converts the radiation energy to heat. The method also includes exposing the powder bed to energy to selectively fuse the polymer particles in contact with the radiation absorber to form a fused polymer matrix at individual build material layers to form a three-dimensional printed object, and applying a post-processing agent to the three-dimensional printed object. The post-processing agent includes a curable epoxy resin, where the epoxy resin, when cured, has a higher elastic modulus than the thermoplastic polymer particles. In some examples, the curable epoxy resin can be a one-part UV-curable epoxy resin and the method can also include curing the epoxy resin with UV radiation. In other examples, the curable epoxy resin can be a two-part composition including an epoxy part and a hardener part, and the method can also include mixing the epoxy part and the hardener part together before applying the post-processing agent to the three-dimensional printed object. In further examples, the post-processing agent can be a 100% solids epoxy coating composition and the post-processing agent can be applied by brush coating the three-dimensional printed object. In still other examples, the post-processing agent can include a diluted epoxy resin in a liquid vehicle and the post-processing agent can be applied by spraying the post-processing agent onto the three-dimensional printed object or soaking the three-dimensional printed object in the post-processing agent. In some examples, the method can also include defining a target elastic modulus of the three-dimensional printed object. The three-dimensional object model can be prepared such that the three-dimensional printed object would have an elastic modulus lower than the target elastic modulus if the three-dimensional printed object was formed from the thermoplastic polymer without the epoxy resin, where applying the post-processing agent increases the elastic modulus of the three-dimensional printed object to the target elastic modulus or higher. In further examples, the three-dimensional printed object can include a lattice structure including a plurality of connected lattice beams. The lattice beams can be exposed to allow the post-processing agent to coat the lattice beams. The present disclosure also describes three-dimensional printed objects including a thickness of cured epoxy resin on a surface of the three-dimensional printed object.

Additionally, the present disclosure describes three-dimensional printing systems. In one example, a three-dimensional printing system includes a powder bed material including thermoplastic polymer particles. A fusing agent applicator is fluidly coupled or coupleable to a fusing agent. The fusing agent applicator is directable to iteratively apply the fusing agent to layers of the powder bed material. The fusing agent includes water and a radiation absorber. The radiation absorber absorbs radiation and converts the radiation energy to heat. The system also includes a radiant energy source positioned to expose the layers of powder bed material to radiation energy to selectively fuse the powder bed material in contact with the electromagnetic radiation absorber and thereby form a three-dimensional printed object. Additionally, the system includes a post-processing agent to apply to the three-dimensional printed object. The post-processing agent includes a curable epoxy resin, where the epoxy resin, when cured, has a higher elastic modulus than the thermoplastic polymer particles. In some examples, the system can also include a post-processing agent applicator. The post-processing agent applicator can include a brush, a sprayer, or a soaking container. In further examples, the curable epoxy resin can be a one-part UV-curable epoxy resin or a two-part composition including an epoxy part and a hardener part.

When discussing the three-dimensional printing kits, methods of making three-dimensional printed objects, and three-dimensional printing Systems described herein, these discussions can be considered applicable to one another whether or not they are explicitly discussed in the context of that example. Thus, for example, when discussing a polymeric build material related to a three-dimensional printing kit, such disclosure is also relevant to and directly supported in the context of the methods of making three-dimensional printed objects, and vice versa.

Terms used herein will have the ordinary meaning in their technical field unless specified otherwise. In some instances, there are terms defined more specifically throughout the specification or included at the end of the present specification, and thus, these terms can have a meaning as described herein.

### Three-Dimensional Printing Kits

The three-dimensional printing kits described herein can be used to make three-dimensional printed objects with increased stiffness. In particular, the three-dimensional printing kits can include a post-processing agent that can be applied to a three-dimensional printed object to increase the stiffness of the object beyond the normal stiffness of the polymer build material making up the three-dimensional printed object. As used herein, “stiffness” can more specifically refer to the elastic modulus of the object. The elastic modulus is the ratio of a force exerted on the object to the deformation resulting from that force, i.e., stress divided by strain. The elastic modulus can also be known as Young's modulus. In addition to increasing the stiffness of the object, the post-processing agent can also increase the tensile strength. Therefore, the three-dimensional printing kits described herein can allow for more control over the mechanical properties of three-dimensional printing kits compared to using a polymeric build material alone.

Some polymeric build materials can be elastomeric polymers. Elastomeric polymers can have a relatively low elastic modulus and tensile strength. As an example, thermoplastic polyamide can be used as a polymer build material in the three-dimensional printing process described herein. However, thermoplastic polyamide may have insufficient stiffness in some applications. The three-dimensional printing kits described herein allow for an increase in the stiffness and tensile strength of thermoplastic polyamide and other elastomeric build materials. A three-dimensional printed object made with an elastomeric build material can be treated with the post-processing agent to increase its stiffness and tensile strength for applications in which those properties are desired.

A design strategy sometimes used in three-dimensional printing is reducing the overall amount of build material used by using a lattice structure made up of hollow cells. This lattice structure, sometimes referred to as an infill, can have relatively good strength while reducing the weight and overall amount of build material used. However, the strength of the lattice structure may be reduced dramatically if the lattice beams are made too thin. The three-dimensional printing kits described herein can be used to make stronger lattice structures, even with thin lattice beams. In some examples, the lattice beams can be designed to be so thin that the three-dimensional printed object would normally not have sufficient strength for a particular application. The post-processing agent can then be applied to the lattice beams to increase the stiffness and strength of the lattice beams. The final object can have sufficient stiffness and strength, while at the same time the total amount of build material used can be reduced to save on weight and the total cost of manufacturing the three-dimensional printed object.

In various examples, three-dimensional printing kits can include a powder bed material, a fusing agent, and a post-processing agent. The powder bed material can include polymer particles that can be melted and fused together to form a solid three-dimensional printed object. The fusing agent can be used with the powder bed material in a particular type of three-dimensional printing process. In the three-dimensional printing process, the fusing agent can be selectively applied to certain portions of a layer of the powder bed material. The fusing agent can include a radiation absorber, which can be a compound or material that absorbs electromagnetic radiation energy (such as UV or infrared radiation) and converts the energy to heat. After applying the fusing agent, a radiation source is used to irradiate the powder bed. The areas of the powder bed where the fusing agent was applied can be selectively heated to a melting or softening point temperature of the polymer particles so that the polymer particles fuse together to form a solid layer of the final three-dimensional printed object. Additional layers of the powder bed material can be added, and the process of applying the fusing agent and irradiating the layers can be repeated to form additional layers until the three-dimensional printed object is completed.

The post-processing agent can be applied to the three-dimensional printed object after the object has been printed. The post-processing agent can include a curable epoxy resin that can be cured to have a higher elastic modulus than the thermoplastic polymer particles in the powder bed material. In various examples, the curable epoxy resin can be cured by a variety of curing methods. In some examples, the epoxy resin can be a two part epoxy resin. For example, the resin can include an epoxy part and a hardener part. When the two parts are mixed together, curing can begin. Curing can be completed at room temperature or with heat, depending on the specific epoxy resin. In other examples, the epoxy resin can be a one part composition. Some epoxy resins can be cured by heating to curing temperature for a curing time. Other epoxy resins can be cured by exposing the resin to ultraviolet (UV) light. Any of these types of curable epoxy resin can be used in the post-processing agent.

As mentioned above, the curable epoxy, when cured, can have a higher elastic modulus than the thermoplastic polymer particles in the powder bed material. In other words, the epoxy can be stiffer than the thermoplastic polymer. Specifically, stating that the epoxy resin has a higher elastic modulus than the thermoplastic polymer particles can mean that a solid object made of the cured epoxy polymer can have a higher elastic modulus than an identically shaped and sized solid object made of the thermoplastic polymer. In some examples, the elastic modulus (also known as Young's modulus) can be measured using ASTM E111-17, “Standard Test Method for Young's Modulus, Tangent Modulus, and Chord Modulus.” The elastic modulus can also be measured using an INSTRON® Tensile Tester, available from Instron (USA).

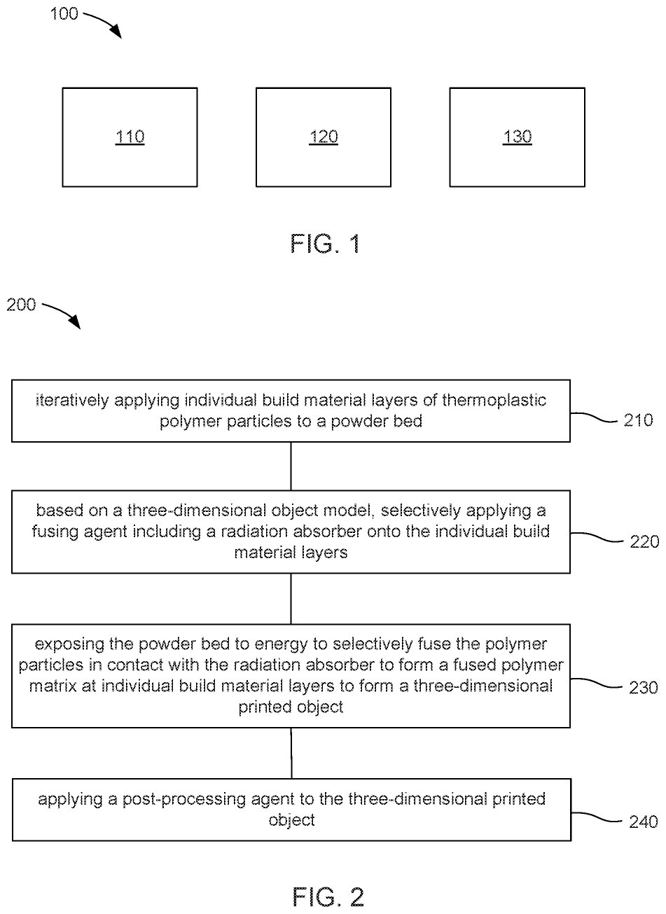

FIG. 1 shows a schematic illustration of one example three-dimensional printing kit 100 in accordance with examples of the present disclosure. The kit includes a powder bed material 110, a fusing agent 120, and a post-processing agent 130. As mentioned above, the powder bed material can include thermoplastic polymer particles. The fusing agent can include water and a radiation absorber. The radiation absorber can absorb radiation and convert the radiation energy to heat. The post-processing agent can include a curable epoxy resin. The epoxy resin, when cured, can have a higher elastic modulus than the thermoplastic polymer particles. Further details about the composition of the powder bed material, fusing agent, and post-processing agent are described below.

In further examples, the three-dimensional printing kits can further include other fluids, such as coloring agents, detailing agents, or the like. A detailing agent, for example, can include a detailing compound, which is a compound that can reduce the temperature of powder bed material onto which the detailing agent is applied. In some examples, the detailing agent can be applied around edges of the area where the fusing agent is applied. This can prevent powder bed material around the edges from caking due to heat from the area where the fusing agent was applied. The detailing agent can also be applied in the same area where fusing was applied in order to control the temperature and prevent excessively high temperatures when the powder bed material is fused.

### Methods of Making Three-Dimensional Printed Objects

The present disclosure also describes methods of making three-dimensional printed objects. These methods can include a treatment with a post-processing agent to increase the stiffness of the three-dimensional printing object as described above. FIG. 2 is a flowchart illustrating one example method 200 of making a three-dimensional printed object. This method includes: iteratively applying individual build material layers of thermoplastic polymer particles to a powder bed 210; based on a three-dimensional object model, selectively applying a fusing agent including a radiation absorber onto the individual build material layers 220; exposing the powder bed to energy to selectively fuse the polymer 2.5 particles in contact with the radiation absorber to form a fused polymer matrix at individual build material layers to form a three-dimensional printed object 230; and applying a post-processing agent to the three-dimensional printed object 240. The post-processing agent can include a curable epoxy resin. The epoxy resin can be cured to increase the elastic modulus of the three-dimensional printed object.

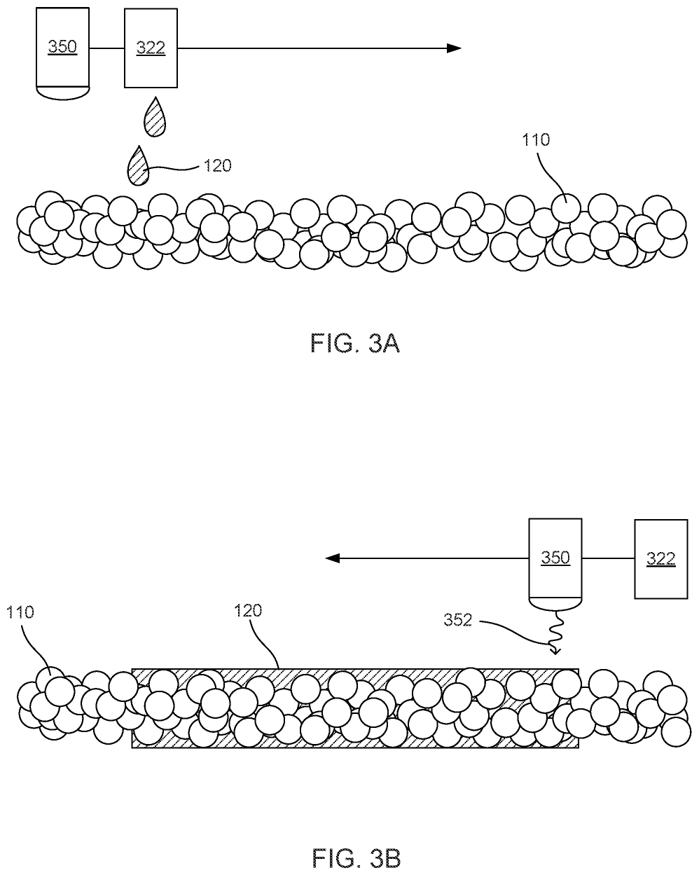

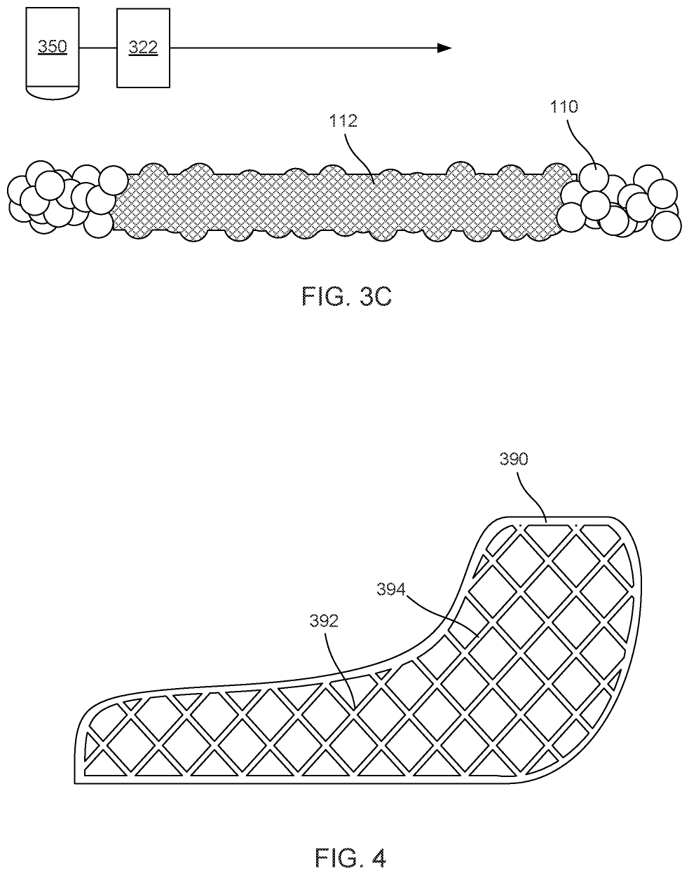

To illustrate the process of forming the three-dimensional printed object, FIGS. 3A-3C illustrate an example system 300, e.g., illustrating one example method that can be used to form a three-dimensional printed object. In FIG. 3A, a fusing agent 120 is applied, e.g., jetted, onto a layer of powder bed material 110, which is a bed including polymeric particles for fusing. The fusing agent is jetted from a fusing agent ejector 322 that can move across the layer of powder bed material to selectively jet fusing agent on areas that are to be fused. A radiation source 350 is also shown, which is described in more detail in the context of FIG. 3B.

The system 300 is further described in FIG. 3B, which shows the layer of powder bed material 110 after the fusing agent 120 has been jetted onto an area of the layer that is to be fused. In this figure, the radiation source 350 is shown emitting radiation 352 toward the layer of polymer particles. The fusing agent can include a radiation absorber that can absorb this radiation and convert the radiation energy to heat.

FIG. 3C shows a layer of powder bed material 110 with a fused portion 112 where the fusing agent was jetted. This portion has reached a sufficient temperature to fuse the polymer particles together to form a solid polymer matrix. For context, the fusing agent ejector 322 and the radiation source 350 are shown in place to apply the next applications of fusing agent and radiation to the next layer of powder bed material, to thereby continue to build the three-dimensional object iteratively.

In some examples, a detailing agent can also be jetted onto the powder bed. The detailing agent can be a fluid that reduces the maximum temperature of the polymer powder on which the detailing agent is printed. In particular, the maximum temperature reached by the powder during exposure to radiation energy can be less in the areas where the detailing agent is applied. In certain examples, the detailing agent can include a solvent that evaporates from the polymer powder to evaporatively cool the polymer powder. The detailing agent can be printed in areas of the powder bed where fusing is not desired. In particular examples, the detailing agent can be printed along the edges of areas where the fusing agent is printed. This can give the fused layer a clean, defined edge where the fused polymer particles end and the adjacent polymer particles remain unfused. In other examples, the detailing agent can be printed in the same area where the fusing agent is printed to control the temperature of the area to be fused. In certain examples, some areas to be fused can tend to overheat, especially in central areas of large fused sections. To control the temperature and avoid overheating (which can lead to melting and slumping of the build material), the detailing agent can be applied to these areas

The fusing agent and, in some cases, detailing agent can be applied onto the powder bed using fluid jet print heads, e.g., jetting or ejecting from printing architecture. The amount of the fusing agent used can be calibrated based the concentration of radiation absorber in the fusing agent, the level of fusing desired for the polymer particles, and other factors. In some examples, the amount of fusing agent printed can be sufficient to contact the radiation absorber with the entire layer of polymer powder. For example, if individual layers of polymer powder can be 100 μm thick, then the fusing agent can penetrate 100 microns into the polymer powder. Other thicknesses can likewise be selected for use for other resolutions. Thus, the fusing agent can heat the polymer powder throughout the entire layer so that the layer can coalesce and bond to the layer below. After forming a solid layer, a new layer of loose powder can be formed, either by lowering the powder bed or by raising the height of a powder roller and rolling a new layer of powder.

In some examples, the powder bed as a whole can be preheated to a temperature below the melting or softening point of the polymer powder. In one example, the preheat temperature can be from about 10° ° C. to about 30° ° C. below the melting or softening point. In another example, the preheat temperature can be within 50° ° C. of the melting or softening point. In a particular example, the preheat temperature can be from about 160° ° C. to about 170° C. and the polymer powder can be polyamide-12 powder. In another example, the preheat temperature can be about 90° ° C. to about 100° C. and the polymer powder can be thermoplastic polyamide. Other preheat temperatures can be appropriate for other types of polymer. Preheating can be accomplished with a lamp or lamps, an oven, a heated support bed, or other types of heaters. In some examples, the entire powder bed can be heated to a substantially uniform temperature.

The powder bed can be irradiated with a fusing lamp. Suitable fusing lamps for use in the methods described herein can include commercially available infrared lamps and halogen lamps. The fusing lamp can be a stationary lamp or a moving lamp. For example, the lamp can be mounted on a track to move horizontally across the powder bed. Such a fusing lamp can make multiple passes over the bed depending on the amount of exposure to coalesce printed layers. The fusing lamp can be configured to irradiate the entire powder bed with a substantially uniform amount of energy. This can selectively coalesce the printed portions with fusing agent leaving the unprinted portions of the polymer powder below the melting or softening point.

In one example, the fusing lamp can be matched with the radiation absorber in the fusing agent so that the fusing lamp emits wavelengths of light that match the peak absorption wavelengths of the radiation absorber. A radiation absorber with a narrow peak at a particular near-infrared wavelength can be used with a fusing lamp that emits a narrow range of wavelengths at approximately the peak wavelength of the radiation absorber. Similarly, a radiation absorber that absorbs a broad range of near-infrared wavelengths can be used with a fusing lamp that emits a broad range of wavelengths. Matching the radiation absorber and the fusing lamp in this way can increase the efficiency of coalescing the polymer particles with the fusing agent printed thereon, while the unprinted polymer particles do not absorb as much light and remain at a lower temperature.

Depending on the amount of radiation absorber present in the polymer powder, the absorbance of the radiation absorber, the preheat temperature, and the melting or softening point of the polymer, an appropriate amount of irradiation can be supplied from the fusing lamp. In some examples, the fusing lamp can irradiate individual layers from about 0.5 to about 10 seconds per pass.

In an example of the three-dimensional printing process, a thin layer of polymer powder can be spread on a bed to form a powder bed. At the beginning of the process, the powder bed can be empty because no polymer particles have been spread at that point, or the first layer can be applied onto an existing powder bed, e.g., support powder that is not used to form the three-dimensional object. For the first layer, the polymer particles can be spread onto an empty build platform. The build platform can be a flat surface made of a material sufficient to withstand the heating conditions of the three-dimensional printing process, such as a metal. Thus, “applying individual build material layers of polymer particles to a powder bed” includes spreading polymer particles onto the empty build platform for the first layer. In other examples, a number of initial layers of polymer powder can be spread before the printing begins. These “blank” layers of powder bed material can in some examples number from about 10 to about 500, from about 10 to about 200, or from about 10 to about 100. In some cases, spreading multiple layers of powder before beginning the printing can increase temperature uniformity of the three-dimensional printed object. A fluid jet printing head, such as an inkjet print head, can then be used to print a fusing agent including a radiation absorber over portions of the powder bed corresponding to a thin layer of the 3D article to be formed. Then the bed can be exposed to electromagnetic energy, e.g., typically the entire bed. The electromagnetic energy can include light, infrared radiation, and so on. The radiation absorber can absorb more energy from the electromagnetic energy than the unprinted powder. The absorbed light energy can be converted to thermal energy, causing the printed portions of the powder to soften and fuse together into a formed layer. After the first layer is formed, a new thin layer of polymer powder can be spread over the powder bed and the process can be repeated to form additional layers until a complete 3D article is printed. Thus, “applying individual build material layers of polymer particles to a powder bed” also includes spreading layers of polymer particles over the loose particles and fused layers beneath the new layer of polymer particles.

The three-dimensional printed object can be formed by jetting a fusing agent onto layers of powder bed build material according to a 3D object model. 3D object models can in some examples be created using computer aided design (CAD) software. 3D object models can be stored in any suitable file format. In some examples, a three-dimensional printed object as described herein can be based on a single 3D object model. The 3D object model can define the three-dimensional shape of the article. Other information may also be included, such as structures to be formed of additional different materials or color data for printing the article with various colors at different locations on the article. The 3D object model may also include features or materials specifically related to jetting fluids on layers of powder bed material, such as the desired amount of fluid to be applied to a given area. This information may be in the form of a droplet saturation, for example, which can instruct a three-dimensional printing system to jet a certain number of droplets of fluid into a specific area. This can allow the three-dimensional printing system to finely control radiation absorption, cooling, color saturation, and so on. All this information can be contained in a single 3D object file or a combination of multiple files. The three-dimensional printed object can be made based on the 3D object model. As used herein, “based on the 3D object model” can refer to printing using a single 3D object model file or a combination of multiple 3D object models that together define the article. In certain examples, software can be used to convert a 3D object model to instructions for a three-dimensional printer to form the article by building up individual layers of build material.

As mentioned above, the post-processing agent including a curable epoxy resin can be applied to the three-dimensional printed object to increase the stiffness and strength of the object. In particular, the epoxy resin can increase the elastic modulus and the tensile strength of the object. In some cases, this can allow the three-dimensional printed object to be intentionally designed to be formed with less build material than normal, which can save weight and the cost of the build material. For example, the three-dimensional object model can be designed with thinner walls, lattice beams, and so on than would normally be used. Using such thin walls or lattice beams could cause the final three-dimensional printed object to have insufficient stiffness or strength if the entire object were made from the thermoplastic polymer powder bed material alone. However, adding the epoxy resin in the post-processing agent can increase the stiffness and strength so that the stiffness and strength can be sufficient even while using less of the thermoplastic polymer build material.

In a certain example, the method of making a three-dimensional printed object can include defining a target elastic modulus of the three-dimensional printed object. Similarly, in other examples, the method can include defining a target tensile strength. A three-dimensional object model can then be prepared such that the three-dimensional printed object would have an elastic modulus or tensile strength lower than the target if the object were formed from the thermoplastic polymer alone, without the epoxy resin. After printing the object based on this three-dimensional object model, the post-processing agent can be applied to the object. The epoxy resin in the post-processing agent can bring the elastic modulus or tensile strength up to the target value, or exceed the target value.

After the three-dimensional object has been initially formed using the process described above, the object can be treated with the post-processing agent using a variety of application methods. For example, the post-processing agent can be applied by brush coating, spray coating, dip coating, soaking the object in the post-processing agent, or other application methods. In some examples, a post-processing agent applicator can be used. The post-processing agent applicator can include a brush, a sprayer, a soaking container, or another piece of equipment that can be used to apply the post-processing agent.

In a particular example, the post-processing agent can be a 100% solids epoxy coating composition. This means that the post-processing agent does not include volatile solvents that evaporate from the post-processing agent when the epoxy resin is curing, or includes negligible amounts of such volatile materials. Thus, the entire liquid volume of the post-processing agent can turn to a solid as the epoxy resin cures. Some 100% solids epoxy coating compositions can be two-part compositions that can cure after the two parts are mixed together. In certain examples, the two parts can be mixed together and then the mixed composition can be applied to the three-dimensional printed object by brushing.

In other examples, the post-processing agent can be a diluted epoxy resin in a liquid vehicle. The liquid vehicle can include solvents such as water and organic solvents that may evaporate when the composition is cured. In some examples, such diluted epoxy resin compositions can be suitable for application by spraying or soaking. In further examples, any application method can be used for either the diluted epoxy resin compositions or the 100% solids compositions.

The methods of making three-dimensional printed objects can also include curing the epoxy resin after the post-processing agent has been applied. In some examples, the epoxy resin can cure at ambient conditions, such as room temperature, without UV radiation. In certain examples, the epoxy resin can cure at ambient conditions after a particular curing time. Depending on the particular epoxy resin, the curing time can be from about 1 minute to about 24 hours, or from about 5 minutes to about 8 hours, or from about 5 minutes to about 2 hours. In some cases, heating can speed up the curing of the epoxy resin. Other epoxy resins can be curable using UV radiation. In some examples, the three-dimensional printed object having the epoxy resin applied thereon can be exposed to UV radiation for a curing time from about 10 seconds to about 8 hours, or from about 30 seconds to about 2 hours, or from about 1 minute to about 1 hour. Other epoxy resins can be one-part compositions that can be cured using heat. In some examples, these epoxy resins can be cured by heating for a curing time from about 1 minute to about 24 hours, or from about 5 minutes to about 8 hours, or from about 5 minutes to about 2 hours.

The post-processing agent can be applied in an appropriate amount to provide a desired coating thickness when the epoxy resin has been cured. In some examples, the thickness of the coating can be adjusted by using post-processing agents having different viscosities, or by changing the amount of the post-processing that is applied by spraying or brushing, or by applying multiple layers of the post-processing agent. In certain examples, the final three-dimensional printed object can have a cured epoxy resin coating with a thickness from about 50 μm to about 5 mm, or from about 50 μm to about 1 mm, or from about 100 μm to about 500 μm.

The mechanical properties of the three-dimensional printed object can depend on the particular powder bed material and post-processing agent that are used. In some examples, the three-dimensional printed object can have an elastic modulus (i.e., Young's modulus) from about 10 MPa to about 500 MPa before the post-processing agent is applied. In further examples, the elastic modulus can be from about 20 MPa to about 250 MPa, or from about 20 MPa to about 100 MPa before the post-processing agent is applied. After the post-processing agent is applied and cured, the elastic modulus of the three-dimensional printed object can be from about 100 MPa to about 1,000 MPa, or from about 150 MPa to about 600 MPa, or from about 150 MPa to about 300 MPa. In further examples, the elastic modulus can increase when the post-processing agent is applied and cured. In certain examples, the final elastic modulus can be from about 2 to about 10 times greater than the elastic modulus before the post-processing agent is applied. In other examples, the final elastic modulus can be from about 3 to about 8 times greater, or from about 4 to about 5 times greater, than the elastic modulus before the post-processing agent is applied.

The tensile strength of the three-dimensional printed object can also increase when the post-processing agent is applied and cured. In some examples, the three-dimensional printed object can have a tensile strength from about 4 MPa to about 7 MPa, or from about 5 MPa to about 7 MPa, or from about 5 MPa to about 6 MPa, before the post-processing agent is applied. After the post-processing agent is applied and cured, the tensile strength can be from about 6 MPa to about 8 MPa, or from about 6 MPa to about 7 MPa, or from about 7 MPa to about 8 MPa. The elastic modulus and the tensile strength can both be measured using an INSTRON® Tensile Tester, available from Instron (USA).

FIG. 4 shows an example three-dimensional printed object 390 made using the methods described herein. The three-dimensional printed object can include a thickness of cured epoxy resin on a surface of the three-dimensional printed object, as described. This particular object includes a lattice structure 392 made up of lattice beams 394, which are the straight thin portions that connect together to form the lattice structure. The lattice beams are exposed to the exterior of the object, allowing the lattice beams to be coated with the epoxy resin from the post-processing agent. This is different from the way infill is often used in the three-dimensional printing, in which the infill is enclosed inside a solid wall or “skin” layer on the exterior of the three-dimensional printed object. However, in some examples the three-dimensional printed objects described herein can include infill portions that are enclosed, but such enclosed portions will not be coated by the post-processing agent.

In certain examples, it can be particularly useful to use the methods described herein to make three-dimensional printed objects in which a low weight and a particular elastic modulus is desirable. The elastic modulus of the three-dimensional printed object can be tuned and adjusted by adjusting variables such as the type of powder bed material, the type of epoxy resin in the post-processing agent, the thickness of the coating of epoxy resin that is applied to the three-dimensional printed object, the thickness of the three-dimensional printed object made of the powder bed material, and so on. Some particular applications in which these methods can be useful include three-dimensional printed footwear components, prosthetics, protective helmets, automotive parts, and others.

### Systems for Three-Dimensional Printing

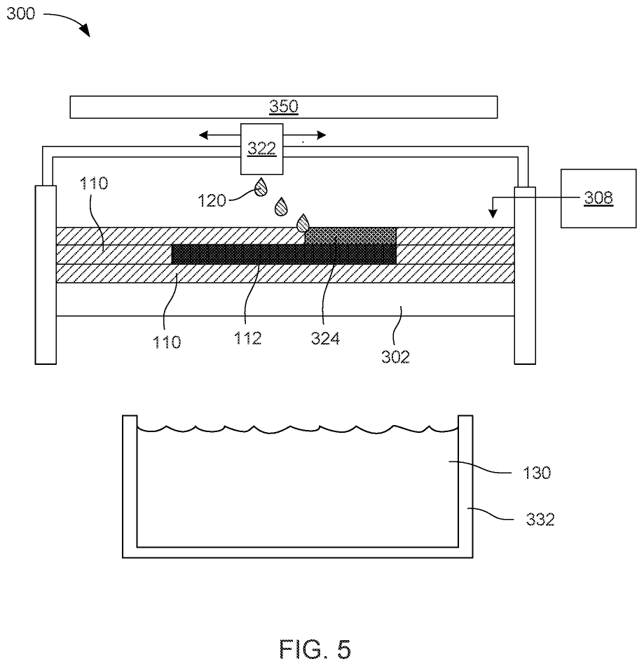

The present disclosure also extends to systems for three-dimensional printing. Portions of the system of three-dimensional printing are shown and described in connection with FIGS. 3A-3C above. Further details are shown in FIG. 5. This figure shows an example three-dimensional printing system 300 that includes the powder bed material 110 and the fusing agent 120 described previously. The systems can also include a radiant energy source 350 positioned to expose the powder bed material to electromagnetic radiation energy to selectively fuse the polymer particles in contact with the radiation absorber from the fusing agent. In some examples, the powder bed material can be distributed in individual layers by a build material applicator 308, and the fusing agent can be jetted onto the layers by a fluid ejector 322. The powder bed material can be spread on a build platform 302. In particular, powder bed material can be deposited onto the build platform by the build material applicator where the powder bed material can be flattened or smoothed, such as by a mechanical roller or other flattening technique. This can form a flat layer of powder bed material. The fusing agent can then be applied to the layer by the fusing agent ejector. The area 324 where the fusing agent is applied can correspond to a layer or slice of a three-dimensional object model. The radiant energy source can be used to apply electromagnetic energy to generate heat at the layers of powder bed material where the fusing agent has been applied. In this particular example, the system includes a radiant energy source that can irradiate the entire powder bed at once instead of a moveable radiant energy source that moves across the powder bed. The radiant energy source can heat the powder bed material and fusing agent until the powder bed material on which the fusing agent was printed reaches a melting or softening point temperature of the powder bed material. The polymer particles can fuse together to form a fused solid polymer matrix 112. In this figure, one layer of solid polymer matrix has already been formed and then a layer of additional powder bed material has been spread over the top of the solid layer. The figure shows the fusing agent being applied to the additional layer, which can then subsequently be heated and fused to add another solid layer to the three-dimensional printed object. This example system also includes a post-processing agent applicator 332, which in this example is a container filled with the post-processing agent 130. The completed three-dimensional printed object can be dipped or soaked in the post-processing agent in this container.

As used herein, “applying individual layers of powder bed material to a powder bed” can include applying the first layer of powder bed material that is applied directly to an empty support bed. The “support bed” can refer to the build platform as shown in FIG. 5, for example. Additionally, in some examples, a layer or multiple layers of powder bed material can be laid on the support bed without jetting any fusing agent onto the layers. This can provide a more thermally uniform temperature profile for the first layer to have the fusing agent jetted thereon. Accordingly, “applying individual layers of a powder bed material to a powder bed” can include applying a layer of powder bed material onto the initial layer or layers that may be applied without any fusing agent. The phrase “applying individual layers of a powder bed material to a powder bed” also includes applying to subsequent layers, when a layer or slice of the three-dimensional printed object has already been formed in the layer below.

In further examples, the system can include a radiant energy source. The radiant energy source can be positioned above the powder bed material as in FIG. 5, or in other examples the heater can be on a side or sides of the powder bed material, or a combination of these locations. In some examples, the support bed can include an additional integrated heater to heat the powder bed material from below to maintain a more uniform temperature in the powder bed. The radiant energy source can be used to heat the areas of the powder bed where fusing agent has been applied to fuse the polymer particles in those areas. In certain examples, the radiant energy source heater can include a heat lamp, infrared heater, halogen lamp, fluorescent lamp, or other type of radiant energy source. In further examples, the radiant energy source can be mounted on a carriage to move across the powder bed. In certain examples, the fusing agent ejector and the radiant energy source can both be mounted on a carriage to move across the powder bed. For example, the fusing agent can be jetted from the fusing agent ejector on a forward pass of the carriage, and the radiant energy source can be activated to irradiate the powder bed on a return pass of the carriage. A coloring agent ejector, detailing ejector, and any other fluid ejectors in the system can also be mounted on the carriage.

### Powder Bed Materials

In certain examples, the powder bed material (i.e., thermoplastic polymer powder or particles) can include polymer particles having a variety of shapes, such as substantially spherical particles or irregularly-shaped particles. In some examples, the polymer powder can be formed into three-dimensional printed objects with a resolution of from about 20 μm to about 150 μm, from about 20 μm to about 100 μm, about 30 μm to about 90 μm, or about 40 μm to about 80 μm. As used herein, “resolution” refers to the size of the smallest feature that can be formed on a three-dimensional printed object. The polymer powder can form layers from about 20 μm to about 150 μm thick, allowing the fused layers of the printed part to have roughly the same thickness. This can provide a resolution in the z-axis (i.e., depth) direction of about 20 μm to about 150 μm, or one of the other sub-range thicknesses set forth above. The polymer powder can also have a sufficiently small particle size and sufficiently regular particle shape to provide about 20 μm to about 150 μm resolution along the x-axis and y-axis (e.g., the axes parallel to the top surface of the powder bed). For example, the polymer powder can have an average particle size from about 20 μm to about 150 μm. In other examples, the average particle size can be from about 20 μm to about 100 μm. Other resolutions along these axes can be from about 20 μm to about 50 μm, from about 30 μm to about 90 μm, or from 40 μm to about 80 μm, for example.

The polymer powder can have a melting or softening point from about 70° ° C. to about 350° C. In further examples, the polymer can have a melting or softening point from about 150° ° C. to about 200° C. A variety of thermoplastic polymers with melting points or softening points in these ranges can be used. For example, the polymer powder can be polyamide-6 powder, polyamide-9 powder, polyamide-11 powder, polyamide-12 powder, polyamide-6,6 powder, polyamide-6,12 powder, thermoplastic polyamide powder, polyamide copolymer powder, polyethylene powder, wax, thermoplastic polyurethane powder, acrylonitrile butadiene styrene powder, amorphous polyamide powder, polymethylmethacrylate powder, ethylene-vinyl acetate powder, polyarylate powder, aromatic polyesters, silicone rubber, polypropylene powder, polyester powder, polycarbonate powder, copolymers of polycarbonate with acrylonitrile butadiene styrene, copolymers of polycarbonate with polyethylene terephthalate, polyether ketone powder, polyacrylate powder, polystyrene powder, polyvinylidene fluoride powder, polyvinylidene fluoride copolymer powder, poly(vinylidene fluoride-trifluoroethylene) powder, poly(vinylidene fluoride-trifluoroethylene-chlorotrifluoroethylene) powder, or mixtures thereof. In a specific example, the polymer powder can be polyamide-12, which can have a melting point from about 175° C. to about 200° C. In another specific example, the polymer powder can be thermoplastic polyamide.

The thermoplastic polymer particles can also, in some cases, be blended with a filler. The filler can include inorganic particles such as alumina, silica, fibers, carbon nanotubes, or combinations thereof. When the thermoplastic polymer particles fuse together, the filler particles can become embedded in the polymer, forming a composite material. In some examples, the filler can include a free-flow agent, anti-caking agent, or the like. Such agents can prevent packing of the powder particles, coat the powder particles and smooth edges to reduce inter-particle friction, and/or absorb moisture. In further examples, a filler can be encapsulated in polymer to form polymer encapsulated particles. For example, glass beads can be encapsulated in a polymer such as a polyamide to form polymer encapsulated particles. In some examples, a weight ratio of thermoplastic polymer to filler in the powder bed material can be from about 100:1 to about 1:2 or from about 5:1 to about 1:1.

### Fusing Agents

The fusing agent can be applied to the powder bed in areas that are to be fused together during three-dimensional printing. The fusing agent can include a radiation absorber to absorb radiant energy and convert the energy to heat. As explained above, the fusing agent can be used with a powder bed material in a particular three-dimensional printing process. A thin layer of powder bed material can be formed, and then the fusing agent can be selectively applied to areas of the powder bed material that are desired to be consolidated to become part of the solid three-dimensional printed object. The fusing agent can be applied, for example, by printing such as with a fluid ejector or fluid jet printhead. Fluid jet printheads can jet the fusing agent in a similar way as an inkjet printhead jetting ink. Accordingly, the fusing agent can be applied with great precision to certain areas of the powder bed material that are desired to form a layer of the final three-dimensional printed object.

In some examples, the amount of radiant energy applied, the amount of fusing agent applied to the powder bed, the concentration of radiation absorber in the fusing agent, and the preheating temperature of the powder bed (i.e., the temperature of the powder bed material prior to printing the fusing agent and irradiating) can be tuned to ensure that the portions of the powder bed printed with the fusing agent will be fused to form a solid layer and the unprinted portions of the powder bed will remain a loose powder. These variables can be referred to as parts of the “print mode” of the three-dimensional printing system. The print mode can include any variables or parameters that can be controlled during three-dimensional printing to affect the outcome of the three-dimensional printing process.

Accordingly, in some examples, the fusing agent can include a radiation absorber that is capable of absorbing electromagnetic radiation to produce heat. In some examples, the radiation absorber can include carbon black pigment particles. These particles can effectively absorb radiation to generate heat. In other examples, different radiation absorbers can be used. A combination of multiple radiation absorbers can also be used in some examples. The radiation absorbers can be colored or colorless. In various examples, the radiation absorber can include glass fiber, titanium dioxide, clay, mica, talc, barium sulfate, calcium carbonate, a near-infrared absorbing dye, a near-infrared absorbing pigment, a conjugated polymer, a dispersant, or combinations thereof. Examples of near-infrared absorbing dyes include aminium dyes, tetraaryldiamine dyes, cyanine dyes, pthalocyanine dyes, dithiolene dyes, and others. In further examples, the radiation absorber can be a near-infrared absorbing conjugated polymer such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof. As used herein, “conjugated” refers to alternating double and single bonds between atoms in a molecule. Thus, “conjugated polymer” refers to a polymer that has a backbone with alternating double and single bonds. In many cases, the radiation absorber can have a peak absorption wavelength in the range of about 800 nm to about 1400 nm.

A variety of near-infrared pigments can also be used. Non-limiting examples can include phosphates having a variety of counterions such as copper, zinc, iron, magnesium, calcium, strontium, the like, and combinations thereof. Non-limiting specific examples of phosphates can include M₂P₂O₇, M₄P₂O₉, M₅P₂O₁₀, M₃(PO₄)₂, M(PO₃)₂, M₂P₄O₁₂, and combinations thereof, where M represents a counterion having an oxidation state of +2, such as those listed above or a combination thereof. For example, M₂P₂O₇ can include compounds such as Cu₂P₂O₇, Cu/MgP₂O₇, Cu/ZnP₂O₇, or any other suitable combination of counterions. It is noted that the phosphates described herein are not limited to counterions having a +2 oxidation state. Other phosphate counterions can also be used to prepare other suitable near-infrared pigments.

Additional near-infrared pigments can include silicates. Silicates can have the same or similar counterions as phosphates. One non-limiting example can include M₂SiO₄, M₂Si₂O₆, and other silicates where M is a counterion having an oxidation state of +2. For example, the silicate M₂Si₂O₆ can include Mg₂Si₂O₆, Mg/CaSi₂O₆, MgCuSi₂O₆, Cu₂Si₂O₆, Cu/ZnSi₂O₆, or other suitable combination of counterions. It is noted that the silicates described herein are not limited to counterions having a +2 oxidation state. Other silicate counterions can also be used to prepare other suitable near-infrared pigments.

In further examples, the radiation absorber can include a metal dithiolene complex. Transition metal dithiolene complexes can exhibit a strong absorption band in the 600 nm to 1600 nm region of the electromagnetic spectrum. In some examples, the central metal atom can be any metal that can form square planer complexes. Non-limiting specific examples include complexes based on nickel, palladium, and platinum.

In further examples, the radiation absorber can include a tungsten bronze or a molybdenum bronze. In certain examples, tungsten bronzes can include compounds having the formula MₓWO₃, where M is a metal other than tungsten and x is equal to or less than 1. Similarly, in some examples, molybdenum bronzes can include compounds having the formula MₓMoO₃, where M is a metal other than molybdenum and x is equal to or less than 1.

A dispersant can be included in the fusing agent in some examples. Dispersants can help disperse the radiation absorbing pigments described above. In some examples, the dispersant itself can also absorb radiation. Non-limiting examples of dispersants that can be included as a radiation absorber, either alone or together with a pigment, can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly (ethylene glycol) p-isooctyl-phenyl ether, sodium polyacrylate, and combinations thereof.

The amount of radiation absorber in the fusing agent can vary depending on the type of radiation absorber. In some examples, the concentration of radiation absorber in the fusing agent can be from about 0.1 wt % to about 20 wt %. In one example, the concentration of radiation absorber in the fusing agent can be from about 0.1 wt % to about 15 wt %. In another example, the concentration can be from about 0.1 wt % to about 8 wt %. In yet another example, the concentration can be from about 0.5 wt % to about 2 wt %. In a particular example, the concentration can be from about 0.5 wt % to about 1.2 wt %. In one example, the radiation absorber can have a concentration in the fusing agent such that after the fusing agent is jetted onto the polymer powder, the amount of radiation absorber in the polymer powder can be from about 0.0003 wt % to about 10 wt %, or from about 0.005 wt % to about 5 wt %, with respect to the weight of the polymer powder.

In some examples, the fusing agent can be jetted onto the polymer powder build material using a fluid jetting device, such as inkjet printing architecture. Accordingly, in some examples, the fusing agent can be formulated to give the fusing agent good jetting performance. Ingredients that can be included in the fusing agent to provide good jetting performance can include a liquid vehicle. Thermal jetting can function by heating the fusing agent to form a vapor bubble that displaces fluid around the bubble, and thereby forces a droplet of fluid out of a jet nozzle. Thus, in some examples the liquid vehicle can include a sufficient amount of an evaporating liquid that can form vapor bubbles when heated. The evaporating liquid can be a solvent such as water, an alcohol, an ether, or a combination thereof.

In some examples, the liquid vehicle formulation can include a co-solvent or co-solvents present in total at from about 1 wt % to about 50 wt %, depending on the jetting architecture. Further, a non-ionic, cationic, and/or anionic surfactant can be present, ranging from about 0.01 wt % to about 5 wt %. In one example, the surfactant can be present in an amount from about 1 wt % to about 5 wt %. The liquid vehicle can include dispersants in an amount from about 0.5 wt % to about 3 wt %. The balance of the formulation can be purified water, and/or other vehicle components such as biocides, viscosity modifiers, material for pH adjustment, sequestering agents, preservatives, and the like. In one example, the liquid vehicle can be predominantly water.

In some examples, a water-dispersible or water-soluble radiation absorber can be used with an aqueous vehicle. Because the radiation absorber is dispersible or soluble in water, an organic co-solvent may not be present, as it may not be included to solubilize the radiation absorber. Therefore, in some examples the fluids can be substantially free of organic solvent, e.g., predominantly water. However, in other examples a co-solvent can be used to help disperse other dyes or pigments, or enhance the jetting properties of the respective fluids. In still further examples, a non-aqueous vehicle can be used with an organic-soluble or organic-dispersible fusing agent.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include 1-aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include, but are not limited to, 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol, 1,2-propanediol, and 1,5-pentanediol.

In certain examples, a high boiling point co-solvent can be included in the fusing agent. The high boiling point co-solvent can be an organic co-solvent that boils at a temperature higher than the temperature of the powder bed during printing. In some examples, the high boiling point co-solvent can have a boiling point above about 250° C. In still further examples, the high boiling point co-solvent can be present in the fusing agent at a concentration from about 1 wt % to about 4 wt %.

In certain examples, the fusing agent can include a polar organic solvent. As used herein, “polar organic solvents” can include organic solvents made up of molecules that have a net dipole moment or in which portions of the molecule have a dipole moment, allowing the solvent to dissolve polar compounds. The polar organic solvent can be a polar protic solvent or a polar aprotic solvent. Examples of polar organic solvents that can be used can include diethylene glycol, triethylene glycol, tetraethylene glycol, C3 to C6 diols, 2-pyrrolidone, hydroxyethyl-2-pyrrolidone, 2-methyl-1,3 propanediol, poly(propylene glycol) with 1, 2, 3, or 4 propylene glycol units, glycerol, and others. In some examples, the polar organic solvent can be present in an amount from about 0.1 wt % to about 20 wt % with respect to the total weight of the fusing agent.

Regarding the surfactant that may be present, a surfactant or surfactants can be used, such as alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the fusing agent may range from about 0.01 wt % to about 20 wt %. Suitable surfactants can include, but are not limited to, liponic esters such as TERGITOL™ 15-S-12, TERGITOL™ 15-S-7 available from Dow Chemical Company (Michigan), LEG-1 and LEG-7; TRITON™ X-100; TRITON™ X-405 available from Dow Chemical Company (Michigan); and sodium dodecylsulfate.

Various other additives can be employed to enhance certain properties of the fusing agent for specific applications. Examples of these additives are those added to inhibit the growth of harmful microorganisms. These additives may be biocides, fungicides, and other microbial agents, which can be used in various formulations. Examples of suitable microbial agents include, but are not limited to, NUOSEPT® (Nudex, Inc., New Jersey), UCARCIDE™ (Union carbide Corp., Texas), VANCIDE® (R.T. Vanderbilt Co., Connecticut), PROXEL® (ICI Americas, New Jersey), and combinations thereof.

Sequestering agents, such as EDTA (ethylene diamine tetra acetic acid), may be included to eliminate the deleterious effects of heavy metal impurities, and buffer solutions may be used to control the pH of the fluid. From about 0.01 wt % to about 2 wt %, for example, can be used. Viscosity modifiers and buffers may also be present, as well as other additives to modify properties of the fluid as desired. Such additives can be present at from about 0.01 wt % to about 20 wt %.

### Detailing Agents

In further examples, the three-dimensional printing kits can include a detailing agent. The detailing agent can include a detailing compound. The detailing compound can be capable of reducing the temperature of the powder bed material onto which the detailing agent is applied. In some examples, the detailing agent can be printed around the edges of the portion of the powder that is printed with the fusing agent. The detailing agent can increase selectivity between the fused and unfused portions of the powder bed by reducing the temperature of the powder around the edges of the portion to be fused.

In some examples, the detailing compound can be a solvent that evaporates at the temperature of the powder bed. In some cases the powder bed can be preheated to a preheat temperature within about 10° ° C. to about 70° C. of the fusing temperature of the polymer powder. Depending on the type of polymer powder used, the preheat temperature can be in the range of about 90° C. to about 200° ° C. or more. The detailing compound can be a solvent that evaporates when it comes into contact with the powder bed at the preheat temperature, thereby cooling the printed portion of the powder bed through evaporative cooling. In certain examples, the detailing agent can include water, co-solvents, or combinations thereof. Non-limiting examples of co-solvents for use in the detailing agent can include xylene, methyl isobutyl ketone, 3-methoxy-3-methyl-1-butyl acetate, ethyl acetate, butyl acetate, propylene glycol monomethyl ether, ethylene glycol mono tert-butyl ether, dipropylene glycol methyl ether, diethylene glycol butyl ether, ethylene glycol monobutyl ether, 3-Methoxy-3-Methyl-1-butanol, isobutyl alcohol, 1,4-butanediol, N,N-dimethyl acetamide, and combinations thereof. In some examples, the detailing agent can be mostly water. In a particular example, the detailing agent can be about 85 wt % water or more. In further examples, the detailing agent can be about 95 wt % water or more. In still further examples, the detailing agent can be substantially devoid of radiation absorbers. That is, in some examples, the detailing agent can be substantially devoid of ingredients that absorb enough radiation energy to cause the powder to fuse. In certain examples, the detailing agent can include colorants such as dyes or pigments, but in small enough amounts that the colorants do not promote fusion of the powder printed with the detailing agent when exposed to the radiation energy.

The detailing agent can also include ingredients to allow the detailing agent to be jetted by a fluid jet printhead. In some examples, the detailing agent can include jettability imparting ingredients such as those in the fusing agent described above. These ingredients can include a liquid vehicle, surfactant, dispersant, co-solvent, biocides, viscosity modifiers, materials for pH adjustment, sequestering agents, preservatives, and so on. These ingredients can be included in any of the amounts described above.

### Post-Processing Agents

As mentioned above, the post-processing agent can include a curable epoxy resin. The epoxy resin, when cured, can have a higher elastic modulus than the thermoplastic polymer particles in the powder bed material. Therefore, applying the post-processing agent to a three-dimensional printed object made of the powder bed material can increase the elastic modulus of the three-dimensional printed object. In various examples, the epoxy resin can be a one-part epoxy resin or a two-part epoxy resin. The epoxy resin can be cured using various curing methods, such as curing by mixing two parts of a two-part epoxy resin, or curing using heat, or curing using UV light. Additionally, in some examples, the post-processing agent can be a 100% solids epoxy resin, meaning that the entire volume of the post-processing agent becomes solid epoxy polymer when cured. In other examples, the post-processing agent can include an epoxy resin diluted in a liquid vehicle. The liquid vehicle can evaporate after the post-processing agent is applied and the epoxy resin can be cured to form the epoxy coating on the three-dimensional printed object.

In certain examples, the three-dimensional printed objects made using the processes described herein can be particularly useful for coating with an epoxy resin composition. The three-dimensional printed objects made using the processes described herein often have a relatively rough surface, which can be helpful for adhering to the epoxy coating. Additionally, the three-dimensional printed objects can often have some degree of porosity, as some void space may remain between the fused thermoplastic polymer particles. The post-processing agent can penetrate into these spaces in some examples. Therefore, the epoxy resin can form a strong bond with the three-dimensional printed object. Using the post-processing agent to increase the stiffness and strength of the three-dimensional printed object is also useful because this allows the mechanical properties of the three-dimensional printed object to be adjusted without changing the composition of the powder bed material or the fusing agent.

A variety of epoxy resins can be used in the post-processing agents described herein. Some examples of compounds that can be included in epoxy resins can include epichlorohydrin, bisphenol A, bisphenol F, tetrabromobisphenol A, bisphenol A diglycidyl ether, and others. In certain examples, epichlorohydrin can react with bisphenol A to form bisphenol A diglycidyl ether and/or oligomers thereof. The bisphenol A diglycidyl ether or oligomer thereof can then react with a hardener to form a solid polymer. In further examples, hardeners for curing epoxy resins can include compounds such as amines, acids, acid anhydrides, phenols, alcohols, thiols, and others. Some examples of commercially available epoxy resins include VVIVID® Optically Clear two part epoxy resin, available from Vvivid Scientific (Canada).

As mentioned above, the post-processing agent can be applied using a variety of application methods or applicators. In some examples, the post-processing agent can be applied by brush coating, spray coating, dip coating, soaking, or other application methods.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, “kit” can be synonymous with and understood to include a plurality of multiple components where the different components can be separately contained (though in some instances co-packaged in separate containers) prior to use, but these components can be combined together during use, such as during the three-dimensional object build processes described herein. The containers can be any type of a vessel, box, or receptacle made of any material.

As used herein, “applying” when referring to a fluid agent that may be used, for example, refers to any technology that can be used to put or place the fluid, e.g., fusing agent, fluid recycling agent, detailing agent, coloring agent, or the like on the polymeric build material or into a layer of polymeric build material for forming a three-dimensional object. For example, “applying” may refer to a variety of dispensing technologies, including “jetting.” “ejecting,” “dropping,” “spraying,” or the like. As mentioned above, in certain examples the fusing agent can be applied by jetting onto a powder bed, while the post-processing agent can be applied after the three-dimensional printed object has been printed. The post-processing agent can be applied by a process such as brush coating, spray coating, dip coating, soaking, or other methods.

As used herein, “jetting” or “ejecting” refers to fluid agents or other compositions that are expelled from ejection or jetting architecture, such as ink-jet architecture. Ink-jet architecture can include thermal or piezoelectric architecture. Additionally, such architecture can be configured to print varying drop sizes such as up to about 20 picoliters, up to about 30 picoliters, or up to about 50 picoliters, etc. Example ranges may include from about 2 picoliters to about 50 picoliters, or from about 3 picoliters to about 12 picoliters.

As used herein, “average particle size” refers to a number average of the diameter of the particles for spherical particles, or a number average of the volume equivalent sphere diameter for non-spherical particles. The volume equivalent sphere diameter is the diameter of a sphere having the same volume as the particle. Average particle size can be measured using a particle analyzer such as the MASTERSIZER™ 3000 available from Malvern Panalytical (United Kingdom). The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, a plurality of items, structural elements, compositional elements, and/or materials may be presented in a common list for convenience. However, these lists should be construed as though the individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates examples of the present disclosure. However, it is to be understood that the following are merely illustrative of the application of the principles of the present disclosure. Numerous modifications and alternative devices, methods, and systems may be devised without departing from the scope of the present disclosure. The appended claims are intended to cover such modifications and arrangements.

### Example 1—Three-Dimensional Printed Objects

A series of sample three-dimensional objects were printed using an HP Multi-jet Fusion 3D® printer. The build material was thermoplastic polyamide powder and the fusing agent included carbon black pigment as a radiation absorber. A total of 10 objects were printed, having a “dogbone” shape with a narrow neck between two wider end portions. This shape is useful for testing mechanical properties of the objects, such as elastic modulus, tensile strength, and elongation at break. 5 of the 10 three-dimensional printed objects were coated with VVIVID® Optically Clear two part epoxy resin by brush coating. The epoxy coating was allowed to harden at room temperature. The remaining 5 objects were left as printed, to be a control group.

### Example 2—Measurement of Elastic Modulus

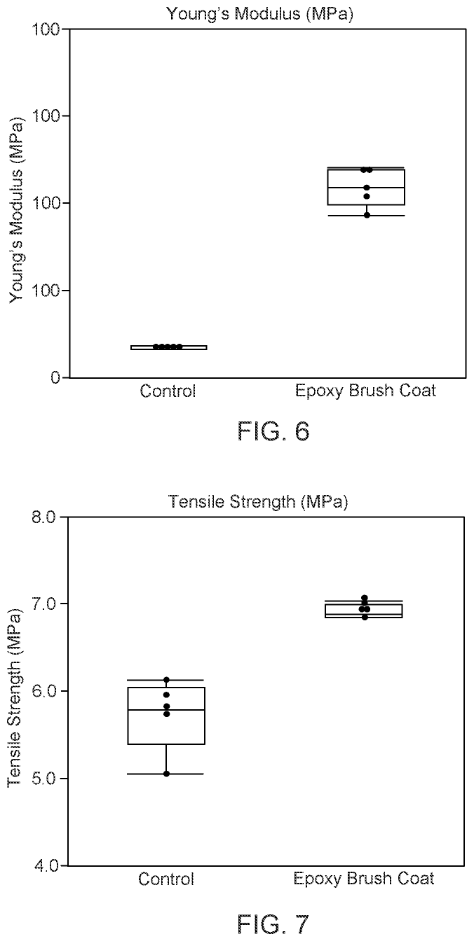

The elastic modulus (or Young's modulus) of the 10 three-dimensional printed objects was tested using an INSTRON® Tensile Tester from Instron (USA). The test results for the sample group and the control group are shown in FIG. 6. The sample group included the 5 objects that were coated with the epoxy resin. The control group included the 5 objects that were printed but not coated with epoxy resin. The results of this test show that the elastic modulus, or stiffness, of the three-dimensional objects increased by about 400% to 500% when the epoxy resin was applied.

### Example 3—Tensile Strength

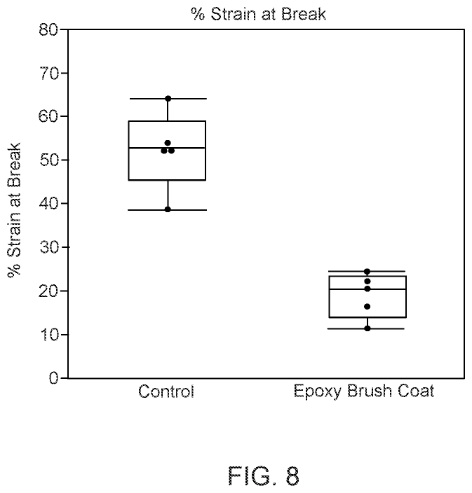

The tensile strength of the 10 three-dimensional printed objects was also measured using the INSTRON® Tensile Tester. The tensile strength measurements are shown in FIG. 7. Again, the control group was not coated with the epoxy resin, and the sample group was coated with the epoxy resin. The test results show that the tensile strength was higher for all of the sample objects compared to the control objects. Thus, the epoxy resin post-processing agent can increase the tensile strength of the three-dimensional printed objects.

### Example 4—Elongation at Break

The elongation at break was also measured for the 10 Three-dimensional printed objects. The results are shown in FIG. 8. This graph shows the elongation at break in the form of the percent strain when the object broke. As shown in the graph, the elongation at break decreased when the epoxy resin was applied. This decrease in elongation at break is expected when the stiffness of the objects increased as in this example. It is expected that the stiffness and the elongation at break can both be adjusted by changing the coating thickness of the epoxy resin, or changing the type of epoxy resin used.

What is claimed is:

1. A three-dimensional printing kit comprising:
a powder bed material comprising thermoplastic polymer particles;
a fusing agent comprising water and a radiation absorber to selectively apply to the powder bed material, wherein the radiation absorber absorbs radiation and converts the radiation energy to heat; and
a post-processing agent to apply to a three-dimensional printed object, wherein the post-processing agent comprises a curable epoxy resin, wherein the epoxy resin, when cured, has a higher elastic modulus than the thermoplastic polymer particles.

2. The three-dimensional printing kit of claim 1, wherein the curable epoxy resin is a one-part UV-curable epoxy resin or a two-part composition comprising an epoxy part and a hardener part.

3. The three-dimensional printing kit of claim 1, wherein the post-processing agent is a 100% solids epoxy coating composition.

4. The three-dimensional printing kit of claim 1, wherein the post-processing agent comprises a diluted epoxy resin in a liquid vehicle.

5. The three-dimensional printing kit of claim 1, wherein the thermoplastic polymer particles comprise polyamide-6, polyamide-9, polyamide-11, polyamide-12, polyamide-6,6, polyamide-6,12, thermoplastic polyamide, polyamide copolymer, polyethylene, thermoplastic polyurethane, polypropylene, polyester, polycarbonate, polyether ketone, polyacrylate, polystyrene, polyvinylidene fluoride, polyvinylidene fluoride copolymer, poly(vinylidene fluoride-trifluoroethylene), poly(vinylidene fluoride-trifluoroethylene-chlorotrifluoroethylene), wax, or a combination thereof

6. The three-dimensional printing kit of claim 1, wherein the radiation absorber is a metal dithiolene complex, carbon black, a near-infrared absorbing dye, a near-infrared absorbing pigment, metal nanoparticles, a tungsten bronze, a molybdenum bronze, a conjugated polymer, or a combination thereof.

7. A method of making a three-dimensional printed object comprising:
iteratively applying individual build material layers of thermoplastic polymer particles to a powder bed;
based on a three-dimensional object model, selectively applying a fusing agent onto the individual build material layers, wherein the fusing agent comprises water and a radiation absorber, wherein the radiation absorber absorbs radiation and converts the radiation energy to heat;
exposing the powder bed to energy to selectively fuse the polymer particles in contact with the radiation absorber to form a fused polymer matrix at individual build material layers to form a three-dimensional printed object; and
applying a post-processing agent to the three-dimensional printed object, wherein the post-processing agent comprises a curable epoxy resin, wherein the epoxy resin, when cured, has a higher elastic modulus than the thermoplastic polymer particles.

8. The method of claim 7, wherein:
the curable epoxy resin is a one-part UV-curable epoxy resin and the method further comprises curing the epoxy resin with UV radiation; or
the curable epoxy resin is a two-part composition comprising an epoxy part and a hardener part, and the method further comprises mixing the epoxy part and the hardener part together before applying the post-processing agent to the three-dimensional printed object.

9. The method of claim 7, wherein:
the post-processing agent is a 100% solids epoxy coating composition and the post-processing agent is applied by brush coating the three-dimensional printed object; or
the post-processing agent comprises a diluted epoxy resin in a liquid vehicle and the post-processing agent is applied by spraying the post-processing agent onto the three-dimensional printed object or soaking the three-dimensional printed object in the post-processing agent.

10. The method of claim 7, further comprising:
defining a target elastic modulus of the three-dimensional printed object; and
preparing the three-dimensional object model such that the three-dimensional printed object would have an elastic modulus lower than the target elastic modulus if the three-dimensional printed object were formed from the thermoplastic polymer without the epoxy resin, wherein applying the post-processing agent increases the elastic modulus of the three-dimensional printed object to the target elastic modulus or higher.

11. The method of claim 7, wherein the three-dimensional printed object comprises a lattice structure comprising a plurality of connected lattice beams, wherein the lattice beams are exposed to allow the post-processing agent to coat the lattice beams.

12. A three-dimensional printed object made using the method of claim 7, wherein the three-dimensional printed object includes a thickness of cured epoxy resin on a surface of the three-dimensional printed object.

13. A three-dimensional printing system comprising:
a powder bed material comprising thermoplastic polymer particles;
a fusing agent applicator fluidly coupled or coupleable to a fusing agent, wherein the fusing agent applicator is directable to iteratively apply the fusing agent to layers of the powder bed material, wherein the fusing agent includes water and a radiation absorber, wherein the radiation absorber absorbs radiation and converts the radiation energy to heat;
a radiant energy source positioned to expose the layers of powder bed material to radiation energy to selectively fuse the powder bed material in contact with the electromagnetic radiation absorber and thereby form a three-dimensional printed object; and
a post-processing agent to apply to the three-dimensional printed object, wherein the post-processing agent comprises a curable epoxy resin, wherein the epoxy resin, when cured, has a higher elastic modulus than the thermoplastic polymer particles.

14. The system of claim 13, further comprising a post-processing agent applicator, wherein the post-processing agent applicator comprises a brush, a sprayer, or a soaking container.

15. The system of claim 13, wherein the curable epoxy resin is a one-part UV-curable epoxy resin or a two-part composition comprising an epoxy part and a hardener part.
